(19) United States
(12) Patent Application Publication
(10) Pub. No.: US 2026/0126767 A1
(43) Pub. Date: May 7, 2026

(54) PRIMARY ODORS FOR OLFACTORY DIGITIZATION

(71) Applicant: MOODIFY LTD., Kefar Sava (IL)

(72) Inventors: Idan AMIT, Ramat Gan (IL); Tzahi KRAWITZ, Kfar Saba (IL); Assa BENTZUR, Tel Aviv (IL); Klio MANIATI, Berlin (DE)

(21) Appl. No.: 19/436,728

(22) Filed: Dec. 30, 2025

Related U.S. Application Data
(63) Continuation of application No. PCT/IL2024/050642, filed on Feb. 7, 2024.
(60) Provisional application No. 63/511,950, filed on Jul. 5, 2023.

(51) Int. Cl. G05B 15/02

(52) U.S. Cl. CPC G05B 15/02

(57) ABSTRACT

There is presented a technique of providing digital olfactory applications using a set of primary odors. The method comprises: obtaining a set of odors corresponding to inventory of odor items, each odor being characterized by its set of odor-related representative aspects in one or more odor-related spaces; and identifying, within the set of odors, all odors validly covering at least one representative aspect of at least one odor (VCA odors with regard to the at least one odor). Data informative of the VCA odors are processed to identify a set of primary odors for at least one odor. The set of primary odors is used in digital olfactory applications (e.g. reformulating a target odor, maintaining an inventory of odor items, etc.). Processing data informative of the VCA odors to identify a set of primary odors can comprise reducing to a set cover problem and applying a set cover algorithm.

### CROSS-REFERENCE TO RELATED APPLICATIONS

This application is a continuation of International Application No. PCT/IL2024/050642 filed on Jul. 2, 2024, which claims the priority benefit under 35 U.S.C. § 119 of U.S. Provisional Patent Application No. 63/511,950, filed on Jul. 5, 2023, the contents of each are hereby incorporated in its entirety by reference.

### TECHNICAL FIELD

The presently disclosed subject matter relates to digital olfactory techniques and, more particularly, to digital olfactory techniques involving primary odors.

### BACKGROUND

Digital olfactory is an emerging field that aims to capture, store, recognize and reproduce scents through digital means. Digital olfactory technologies enable generating, transmitting, and receiving smell-enabled digital media usable for communication, gaming, virtual reality, extended reality, e-commerce, automotive and other applications. Likewise, digital olfactory is usable for a wide range of other applications, for example detection of diseases through breath, air quality surveillance, the food and beverage processing, fragrance engineering, etc.

An application incorporating a digital olfactory technique is referred to hereinafter as a digital olfactory application.

Practical realization of digital olfactory technologies can be achieved with the help of the concept of primary odors. Similarly to primary colors in visual representation, primary odors can be mixed in different proportions to produce a wide spectrum of scents as well as encode and reproduce olfactory information and enable accurate and consistent olfactory experiences across various applications.

Identifying a set of primary odors for olfactory digitization is a complex task, and various approaches have been explored, for example:

Odor Prism by Hans Henning proposes a prism-shaped graphic representation of six primary odors and their relationships. Burnt, spicy, resinous, foul, fruity, and flowery are the primary odors that occupy the corners of the prism, and each surface represents the positions of odors in accordance with their similarity to the primary odors at the corners of that surface.

Chemical Component Analysis proposes identifying the primary odors by analyzing the chemical composition of different odors.

Perceptual Space Mapping involves collecting data on how humans perceive similarities and differences between various odors. Multidimensional scaling (MDS) then maps these perceptions into a spatial model, helping to identify primary odors that are perceptually distinct.

Principal Component Analysis (PCA) represents each odor by a vector of features and applies a mathematical technique to reduce the dimensionality of odor data while preserving as much variance as possible. Thereby PCA enables discovering clusters of similar odors and identifying the primary odors.

### GENERAL DESCRIPTION

The inventor has appreciated that there is a need to downscale an entire collection of odors items to a set of primary odors from which all other odors in the collection can be derived with a required similarity.

The similarity of smells indicates the degree to which it is challenging to distinguish between two or more odors. Odors are considered similar if their discriminability, as assessed by the designated observer(s) (by a human observer and/or by a machine) in the specified odor-related space(s), is below the defined distinction threshold.

Direct methods of smell distinction are based on conducting experiments that measure distinction and/or similarity of smells. For example, it is common to measure smell similarity by asking people to rank in a 0 to 100 scale how similar the smells are, asking whether two smells are distinct, asking to find the different smell between three smells, etc. One of the problems with such distinction tests is that they cannot quantify distinct yet close smells. Orange, lemon and gasoline are distinguishable, yet orange and lemon are closer to each other than to gasoline.

Indirect methods involve external sources of information for learning smells similarity (e.g. a perceptual database, chemical database, etc.). A common indirect similarity metrics family can be based on the application of general-purpose distance functions (e.g., Euclidean distance, cosine, Jaccard) to smell properties databases. Indirect methods can be based on semantics, chemical, biological properties, and/or perceptual properties.

By way of non-limiting example, a review of the smell distinction methods known in contemporary art can be found in the article of Wise et al. (P. M. Wise, M. J. Olsson, and W. S. Cain. Quantification of odor quality. Chemical senses, 25 (4): 429-443, 2000) incorporated herein by reference.

Non-limiting example of providing quantified characteristics of similarity is detailed in International Application No. WO24/194866 assigned to the Assignee of the present application and incorporated herewith by reference.

Similarity requirements can specify: the observer(s) type (human, machine, or both), the odor-related space(s) used for evaluation; set of odor-related representative aspects used for evaluation, the metric of distinction (e.g., similarity score, distance, classification error, confusion rate); the acceptance threshold defining “difficult to distinguish”, etc.

In accordance with certain aspects of the presently disclosed subject matter there is provided a computerized method of providing a digital olfactory application. The method comprises obtaining a set of odors corresponding to an inventory of odor items, each odor being characterized by its set of odor-related representative aspects in one or more odor-related spaces (e.g. perceptual-based space, receptor-based space, etc.). The method further comprises: for at least one odor, identifying, within the set of odors, all odors validly covering at least one representative aspect thereof, thus giving rise to VCA odors with regard to the at least one odor; processing data informative of the VCA odors to identify a set of primary odors for the at least one odor; and using the set of primary odors in a digital olfactory application.

The method can further comprise identifying VCA odors with regard to all odors in the set of odors; and processing data informative of the VCA odors to identify a set of primary odors for all odors in the set of odors.

In accordance with further aspects and, optionally, in combination with other aspects of the presently disclosed subject matter, when a given representative aspect of a certain odor is associated with a binary representative value, a given odor is considered as validly covering the representative aspect of the certain odor when:
the given odor belongs to the set of odors;
the given odor is characterized, at least, by the representative aspect; and
the given odor is not characterized by any representative aspect out of the set of representative aspects of the certain odor.

Further, when a representative aspect of a certain odor is associated with a non-binary representative value, a given odor is considered as validly covering the representative aspect of the certain odor when:
the given odor belongs to the set of odors;
the given odor is characterized by the at least one representative aspect with associated representative value that is not lower than respective non-binary representative value of the at least one odor; and
when the given odor is characterized by a representative aspect out of the set of representative aspects of the at least one odor, a representative value associated with said respective aspect is negligible.

In accordance with further aspects and, optionally, in combination with other aspects of the presently disclosed subject matter, processing data informative of the VCA odors to identify the set of primary odors can comprise reducing to a set cover problem and applying a set cover algorithm.

In accordance with further aspects and, optionally, in combination with other aspects of the presently disclosed subject matter, identifying the set of primary odors can be provided in accordance with similarity requirements, wherein the similarity requirements can be configured differently for different odor items or groups thereof.

In accordance with further aspects and, optionally, in combination with other aspects of the presently disclosed subject matter, at least part of the odor items can be represented by mixtures of respective material sources.

In accordance with further aspects and, optionally, in combination with other aspects of the presently disclosed subject matter, at least part of the primary odors can correspond to mixtures of the odor items from the inventory.

In accordance with further aspects and, optionally, in combination with other aspects of the presently disclosed subject matter, the digital olfactory application is reformulating a target odor, the inventory of odor items comprises odor items testable during the reformulating, the at least one odor is the target odor and the identified set of primaries is usable for removing from the inventory redundant odor items similarly contributing to the target odor and/or removing irrelevant odor items not contributing into the target odor.

In accordance with further aspects and, optionally, in combination with other aspects of the presently disclosed subject matter, the digital olfactory application is maintaining the inventory of odor items, and the identified set of primaries is usable for optimizing the inventory by removing from an inventory listing at least part of redundant odor items.

In accordance with other aspects of the presently disclosed subject matter, there is provided a computing system configured to perform the operations of the method above.

In accordance with other aspects of the presently disclosed subject matter, there is provided a non-transitory computer-readable medium comprising instructions that, when executed by a computing system comprising a memory storing a plurality of program components executable by the computing system, cause the computing system to operate in accordance with the method above.

### BRIEF DESCRIPTION OF THE DRAWINGS

In order to understand the presently disclosed subject matter and to see how it can be carried out in practice, embodiments will be described, by way of non-limiting examples, with reference to the accompanying drawings, in which:

FIGS. 1a and 1b illustrate generalized flow-charts of a method of identifying a set of primary odors in accordance with certain embodiments of the presently disclosed subject matter;

FIG. 2 illustrates a generalized flow-chart of reformulating an odor of interest in accordance with certain embodiments of the presently disclosed subject matter;

FIG. 3 illustrates a generalized flow-chart of maintaining an inventory of odor items in accordance with certain embodiments of the presently disclosed subject matter; and

FIG. 4 illustrates a generalized block diagram of a computing system capable of identifying a set of primary odors in accordance with certain embodiments of the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “applying”, “generating”, “identifying”, “determining”, or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of a non-limiting example, the computing system and processing and memory circuitry therein disclosed in the present application.

The operations in accordance with the teachings herein may be performed by a computer specially constructed for the desired purposes or by a general-purpose computer specially configured for the desired purpose by a computer program stored in a non-transitory computer-readable storage medium.

Unless specifically stated otherwise, the terms “mixture of odors in proportion A” “combination of odors in proportion A” or alike cover also a combination of individual material sources of different odors that are taken in proportion A and are perceived simultaneously.

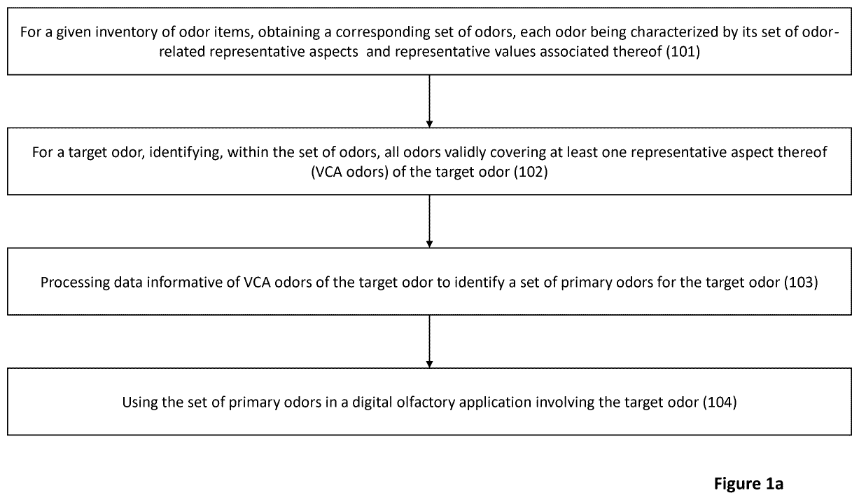

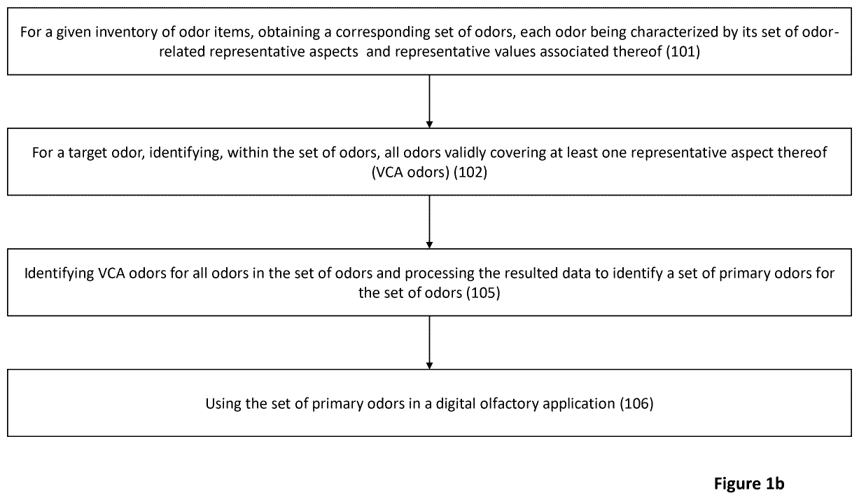

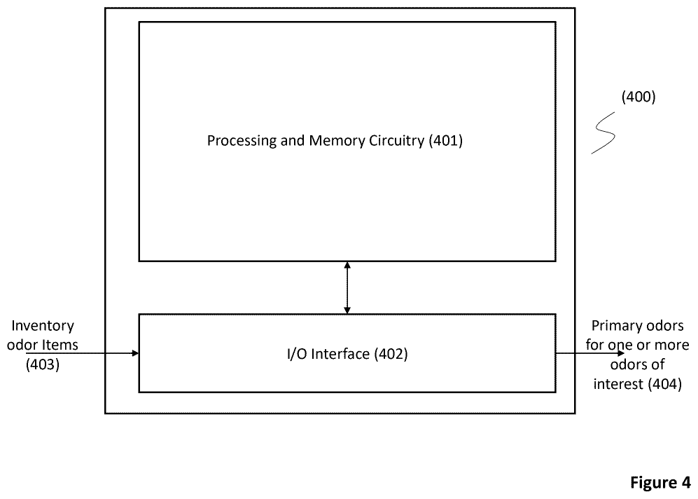

Bearing this in mind, attention is drawn to FIGS. 1a and 1b illustrating generalized flow-charts of a computerized method of identifying a set of primary odors in accordance with certain embodiments of the presently disclosed subject matter. The operations can be provided by computing system 400 detailed with reference to FIG. 4.

Each given odor item (an odor or its material source) can be characterized by a set of its representative aspects in one or more odor-related spaces. By way of a non-limiting example, in a perceptual-based space, the representative aspects can be informative of descriptors of the odors (e.g. “sweet”, “citrus”, “metallic”, etc.). By way of another non-limiting example, in a receptor-based space the representative aspects can be informative of such aspects of the odors as smell receptors activatable by a given odor.

Representative aspects can be associated with representative values. In certain embodiments, the representative values are binary and indicate presence or absence of a given representative aspect in odor's characteristics. In other embodiments, at least part of the representative aspects can be characterized by non-binary representative values (e.g. values indicative of intensity of a certain scent, receptor's sensitivity, weight of the aspect in the set of aspects, etc.).

Thus, for a given inventory of odor items, there can be obtained (101) data informative of a set of odors D with one-to-one relationship to inventory odor items, each odor being characterized by its set of odor-related representative aspects and representative values associated thereof.

It is noted that in certain embodiments all aspects characterizing an odor can be considered as representative aspects. In other embodiments, the representative aspects can be selected from the odor's characteristics in accordance with their importance for similarity between odors. For example, in a perceptual-based space the “Fruity” and “Sulfurous” descriptors can be considered as representative aspects, while “Fresh” descriptor can be considered as non-representative aspect as having low impact on the similarity. Various examples of the importance of different descriptor for odors' similarity can be found in the listing “C. The Good Scents. Flavor, fragrance, food and cosmetics ingredients information, 2023” by The Good Scents Company Information System.

The set of odors D=i₁, . . . , iₙ can be represented by a subset of primary odors P=p₁, . . . pᵢ, any pᵢ€D. The set of odors D is considered as represented by the subset P when for any given odor i€D exists a weighted combination of primary odors Σwᵢpᵢ (0≤weight wᵢ≤1), wherein similarity of the given odor i and an odor of the weighted combination matches similarity requirements.

Thus, any odor item of interest (referred to hereinafter as a target odor) t in set D can be formally presented as:

$$similar ( t , {Σw}_{i} {p}_{i} ) \qquad ( 1 )$$

In accordance with certain embodiments of the presently disclosed subject matter, identifying the set P of primary odors can include identifying (102) for a target odor t€D all odors i€D validly covering at least one representative aspect thereof (such odors are referred to hereinafter as VCA odors).

For a binary representative aspect, an odor is considered as validly covering at least the representative aspect a (such odor is referred to hereinafter also as VCA odor with regard to representative aspect a) of a target odor t€D subject to the following conditions:
the VCA odor belongs to set D;
the VCA odor is characterized by, at least, the representative aspect a; and
the VCA odor is not characterized by any representative aspect out of the set of representative aspects of the target odor t.

For a representative aspect associated with a non-binary representative value, an odor is considered as VCA odor with regard to representative aspect a (i.e. as validly covering at least representative aspect a of a target odor t€D) subject to the following conditions:
the VCA odor belongs to set D;
the VCA odor is characterized by, at least, the representative aspect a with a representative value not lower than a respective representative value of the target odor t; and
if the VCA odor is characterized by a representative aspect out of the set of representative aspects of the target odor t, the representative value associated with the respective aspect is negligible.

Due to the additive features of odor items, a combination of odors can be characterized as a union of their representative aspects. Thus, the VCA odors identified for the target smell t can be combined into a mixture characterized by the same (subject to a required similarity) set of the representative aspects as the target odor t. VCA odors in such mixture are referred to hereinafter as primary odors constituting a set P′ of primary odors of the target odor. Accordingly, data informative of VCA odors of the target odor t are processed to identify (103) a set of primary odors for the target odor.

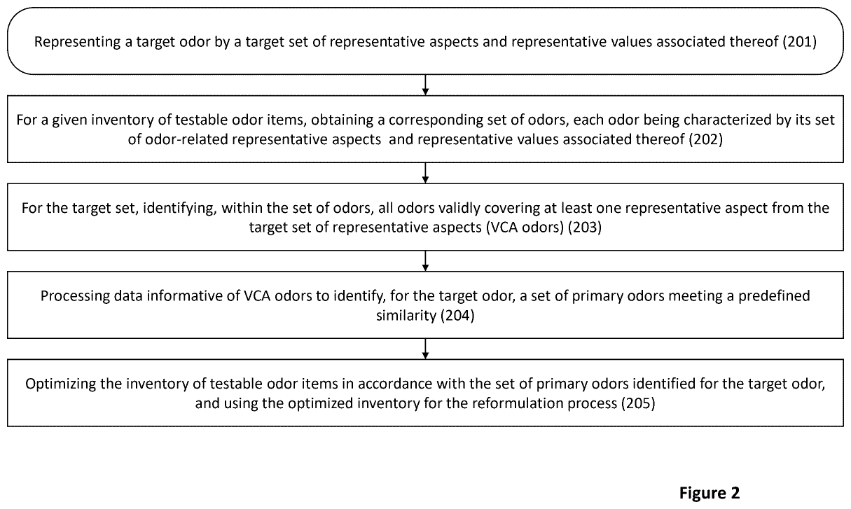

The set P′ of primary odors of a given odor can be further used (104) in a digital olfactory application (e.g. to replace the target odor). By way of non-limiting example, such set of primary odors can be used in a reformulation application as further detailed with reference to FIG. 2.

### Non-Limiting Example for a Receptor-Based Space

Referring to a receptor-based space, set rₜ of representative aspects characterizing a target odor t can be informative of smell receptors (biological and/or electronical) activatable by the target odor, rₜ=r₁, . . . , rₙ.

In certain embodiments, a mixture of VCA odors can be considered similar to the target odor t when it can activate exactly the same receptors as activatable by the target odor t. Accordingly, such mixture is considered as a set of primary odors, P′=(p₁, . . . , pⱼ), each primary odor p characterized by at least one respective representative aspect rₚ.

Formally presenting:

$${r}_{t} = {⋃}_{p ϵ {P}^{′}} {r}_{P} \qquad ( 2 )$$

In other embodiments, the similarity between the set of primary odors and the target odor can be achieved, for example, when exists the valid covering of only a part of receptors (e.g. common receptors, functionally important receptors, certain percentage of receptors, etc.). Reducing the number of receptors to be covered can reduce the size of the set P′ of primary odors.

Due to the additive features of odor items, the combination of odors a and b can be presented as the union of their activatable receptors:

$$a + b = {r}_{a} ⋃ {r}_{b} \qquad ( 3 )$$

Hence, for the target odor t, a primary odor p validly covers a binary representative aspect characterized by a receptor r∈rₜ (i.e.) if and only if

$$r ϵ {r}_{p} and ⋃ {r}_{p} ⊆ {r}_{t} \qquad ( 4 )$$

It noted that in the above example it was assumed that a receptor is uniformly activated by any odor that is bound to it. However, empirical data shows that binding of an odor to a receptor is not only a binary value, and odor-receptor interactions are unique in terms of binding characteristics. Furthermore, an odor can be bound to a variety of different receptors and can influence other odor-receptor interactions. If an odor A binds to receptor R (binary relationship), their interaction is then also characterized by the strength (continuous value) of the activation of the receptor and the corresponding sensory neuron. In such cases, computing the binding characteristics of each odor-receptor pair and correcting the odor concentration in the source should increase the efficacy of the primary odors.

Each odor molecule has a distinct activation strength per active receptor it binds. Therefore, if a different odor B also binds to R with its specific strength, the effect of both A and B on R is additive, which will result in a specific activity of R.

The process of identifying primary odors in this case comprises identifying VCA odors corresponding to all activatable receptors of the target odor (or a group thereof) in association with respective representative values indicative of the above strength.

It is further noted that, in the above example, the representative aspects have been considered as completely distinguishable (one receptor—one aspect). However, in practice, each odor is represented by a set of active receptors, where similar odors are represented by similar sets of active receptors. In such a case, a VCA odor validly covering one of such set of receptors will validly cover the other set of receptors (thus reducing the number of primary odors in the set).

### Non-Limiting Example for a Perceptual-Based Space

Referring to a perceptual-based space, set of representative aspects characterizing a target odor can be represented by perceptual descriptors (e.g., ‘Metallic’, ‘Plastic’, ‘Medicinal’, etc.). Examples of such representation are disclosed in the article by Keller et al incorporated herein by reference (A. Keller, R. C. Gerkin, Y. Guan, A. Dhurandhar, G. Turu, B. Szalai, J. D. Mainland, Y. Ihara, C. W. Yu, R. Wolfinger, et al. Predicting human olfactory perception from chemical features of odor molecules. Science, 355 (6327): 820-826, 2017).

Thus, in a perceptual-based space set dₜ of representative aspects, characterizing a target odor t can be informative of a set of smell descriptors dₜ=d₁, . . . , dₙ stimulated by the target odor. A mixture of VCA odors can be considered similar to the target odor t when it can activate exactly the same descriptors as activatable by the target odor t. Accordingly, such mixture is considered as a set of primary odors, P′=(p₁, . . . , pⱼ), each primary odor p characterized by at least one respective representative item dₚ.

Formally presenting:

$${d}_{t} = {⋃}_{p ϵ {P}^{′}} {d}_{P} \qquad ( 5 )$$

The combination of odors a and b can be presented as the union of their descriptors:

$$a + b = {d}_{a} ⋃ {d}_{b} \qquad ( 6 )$$

Hence, for the target odor t, a primary odor p is a valid cover of a representative aspect characterized by a descriptor d∈dₜ if and only if

$$d ϵ {d}_{p} and ⋃ {d}_{p} ⊆ {d}_{t} \qquad ( 7 )$$

In the above example the descriptors are considered as binary. It is noted that the descriptors can be associated with other representative values (e.g. as described in the above-referenced article by Keller et al). In such a case, an odor is considered as validly covering a target descriptor d€dₜ if its representative value associated with descriptor d is not lower than the respective value of the target odor t (so it can be diluted), and if representative values of any descriptors out of dₜ are negligible (minor side effects).

Referring to the generalized flow-chart in FIG. 1b, the method can, alternatively or additionally, comprise identifying VCA odors for all odors in the set of odors and using the additivity properties to process the resulted data and to identify (105) a set P of primary odors for the entire set of odors D.

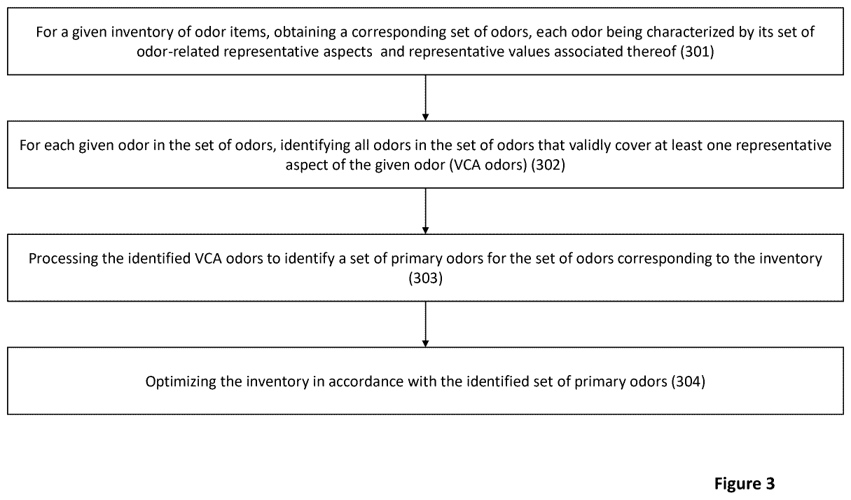

Such a set of primary odors can be further used (106) in a variety of digital olfactory applications. By way of non-limiting example, a set of primary odors of a given inventory can be used in an inventory maintenance application as further detailed with reference to FIG. 3.

In accordance with certain embodiments of the presently disclosed subject matter, for a target odor and/or a set D of odors the described above process of identifying a set of primary odors can be reduced to a set cover problem. Non-limiting examples of reduction to set cover problem are disclosed in the article of R. M. Karp incorporate herein by reference (R. M. Karp. Reducibility among combinatorial problems, Materials of symposium “Complexity of computer computations”, 1972)

Given a set of odors D, a list of representative aspects A=a₁, . . . , aₙ, a set cover problem can be constructed in the following way:
each odor of set D is a potential member p of the set of primary odors P;
each representative aspect a of a given target odor t∈D is a set Tₐ to be covered;
the members of Tₐ are all those p∈D that validly cover representative aspect a of the given target odor t.

It is noted that while in certain embodiments the representative aspects are exactly defined, in other embodiments they can be defined with the help of labeling functions providing a computable verified heuristic. Non-limiting examples of applying the labeling functions are described in U.S. Pat. No. 11,468,358.

Once reduced to the set cover problem, the set of primary odors can be identified with the help of any appropriate set cover algorithm. Set cover is an NP-Complete problem for which no polynomial algorithm is known. A common solution is the use of the greedy set cover algorithm (e.g. as described in the article by V. Chvatal incorporated herewith by reference (V. Chvatal. A greedy heuristic for the set-covering problem. Mathematics of operations research, 4(3):233-235, 1979). Likewise, it can be solved using an exponential algorithm for set cover problems with a low number of sets. One can reduce the set cover problem into SAT problem (e.g. as described in the article by Cook incorporated herewith by reference (S. A. Cook. The complexity of theorem-proving procedures. In Proceedings of the third annual ACM symposium on theory of computing, pages 151-158, 1971).

It is noted that similarity is used herein as a parameter and different similarity requirements can result in different sets P of primary odors. For example, increased requirements of similarity threshold between the target odor(s) and the set of primary odors can lead to an increased number of the primary odors in the set, and vice versa. Alternatively or additionally, similarity between representative aspects can lead to reduction of the required set of primary odors.

In certain embodiments, similarity requirements can be configured differently for different odor items (or groups thereof) in the inventory. Thus, identifying VCA odors and/or respective primary items can be provided with different similarity for different odors.

It is further noted that a domain of odors in the set D can have a significant influence on the set of primary odors. As similar odors tend to share descriptors and/or receptors, a set of similar odors (e.g., citrus, flowers) usually can be represented by a smaller set of primary odors than a set of unrelated ones.

In accordance with further aspects of the presently disclosed subject matter, at least part of odor items in the inventory can be represented by mixtures of respective material sources.

In certain embodiments, at least part of the primary odors can be represented by mixtures of odor items from the inventory (e.g. the mixtures characterized by respective perceptual signatures).

Referring to FIG. 2, there is illustrated a generalized flow-chart of computerized reformulating a target odor in accordance with certain embodiments of the presently disclosed subject matter.

Existing odor formulations can be re-formulated to enhance their performance, accuracy, user experience, etc. Odor reformulation enables optimizing/replacing ingredients and proportions thereof in the existing odors, creating new odors, addressing safety and regulatory concerns, etc.

The reformulation process is considered in the industry as an art which involves multiple steps of trial and error. One of the challenges of odor reformulation is the excessively large number of potential candidates (referred to hereinafter also as “odor items testable during the reformulation process”) and mixtures thereof to be tested.

In accordance with certain embodiments of the presently disclosed subject matter, identifying and using primary odors can significantly improve the effectiveness of reformulation process by optimizing the inventory of testable odor items. The primary odors enable reducing the number of candidates by removing redundant odor items similarly contributing to a target odor and/or removing irrelevant odor items not contributing into the target odor.

A target odor is represented (201) by a target set of representative aspects and representative values associated thereof. The re-formulation process comprises obtaining (202) a set of odors corresponding to an inventory of odor items testable during the reformulation process, each odor being characterized by its set of odor-related representative aspects and the associated representative values.

The process further comprises identifying (203) all odors, among the set of odors, that validly cover at least one representative aspect of the target set of representative aspects (VCA odors); and processing data informative of VCA odors to identify (204), for the target odor, a target set of primary odors meeting a defined similarity.

It is noted that the target odor can be represented by a formula specifying the ingredients and proportions thereof. Optionally in such a case, the process can comprise identifying respective sets of primary odors for one or more ingredients or for one or more groups of ingredients.

The inventory of odor items testable during the reformulation process is further optimized (205) in accordance with the set of primary odors identified for the target odor. The optimization can include removing from the inventory such odor items that characterized by the similar combinations of primary odors from the target set of primary odors (i.e. similarly contributing to a target odor); removing from the inventory such odor items that are not characterized by primary odors from the target set of primary odors (i.e. irrelevant for the target odor), etc.

As was detailed with reference to FIG. 1, different similarity requirements can result in different sets of primary odors. Accordingly, the reformulation process can further include changing one or more similarity requirements (e.g., selected representative aspects and/or values thereof, similarity requirements for valid covering, etc.) to obtain an updated set of primary odors and obtaining an updated optimized inventory corresponding to the updated set of primary odors. Thus, the inventory of odor items testable during the reformulation process can be updated in accordance with updated similarity requirements.

FIG. 3 illustrates a generalized flow-chart of computerized maintaining an inventory of odor items. The operations can be provided by computing system 400 detailed with reference to FIG. 4.

Maintaining a large inventory of odor items can lead to increased costs, management complexity, risks of obsolescence, operational inefficiencies and other problems. In accordance with certain embodiments of the presently disclosed subject matter, the problems can be mitigated by reducing the listing of odor items with the help of primary odors, whilst keeping the capability of producing required odors.

The method of maintaining an inventory of odor items comprises, by a computer: obtaining (301), for a given inventory of odor items, a corresponding set of odors, each odor being characterized by its set of odor-related representative aspects and representative values associated thereof; and identifying (302), for each given odor in the set of odors, all odors in the set of odors that validly cover at least one representative aspect of the given odor (VCA odors). The method further comprises processing the identified VCA odors to identify (303) a set of primary odors of the set of odors corresponding to the inventory; and optimizing (304) the inventory in accordance with the identified set of primary odors.

Optimization can include removing from the inventory listing at least part of redundant odor items with the similar sets of primary odors; removing from the inventory listing at least part of odor items being mixtures of other odor items in the inventory, such mixtures defined with the help of respective primary odors representing the odor items, etc.

Referring to FIG. 4, there is illustrated a generalized block diagram of a computing system capable of identifying primary odors in accordance with certain embodiments of the presently disclosed subject matter. The illustrated system 400 comprises input/output interface 402 operatively connected processing and memory circuitry (PMC) 401 comprising a processor and a memory (not shown separately within the PMC).

The system is configured to receive data informative of an inventory of odor items 403 via input/output interface 402. PMC 401 is configured to execute computer-readable instructions implemented on a non-transitory computer-readable storage medium. The instructions, when executed by PMC 401 cause the computing system to process data informative of the received inventory of odor items 403 and enable identification primary odors 404 as detailed with reference to FIGS. 1-3. Computing system 400 is further configured to use the identified primary odors in one or more digital olfactory applications (e.g. reformulating a target odor, maintaining an inventory of odor items, etc.) and/or output the identified primary odors via input/output interface 402.

The computing system 400 can be a standalone entity, or can be integrated, fully or partly, with other systems.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the presently disclosed subject matter may be, at least partly, implemented on a suitably programmed computer. Likewise, the presently disclosed subject matter contemplates a computer program being readable by a computer for executing the method of the presently disclosed subject matter. The presently disclosed subject matter further contemplates a non-transitory computer-readable memory tangibly embodying a program of instructions executable by the computer for executing the method of the presently disclosed subject matter.

Those skilled in the art will readily appreciate that various modifications and changes can be applied to the embodiments of the presently disclosed subject matter as hereinbefore described without departing from its scope, defined in and by the appended claims.

1. A computerized method of providing a digital olfactory application incorporating a digital olfactory technique, the method comprising, by a computer:
obtaining data informative of a set of odors corresponding to an inventory of odor items, each odor being characterized by its set of odor-related representative aspects in one or more odor-related spaces;
for a first odor, identifying, within the set of odors, all odors that validly cover the set of representative aspect of the first order, thus giving rise to VCA odors with regard to the first odor;
processing data informative of the VCA odors to identify a set of primary odors for the first odor; and
using the set of primary odors in the digital olfactory application.

2. The method of claim 1, wherein at least one representative aspect of the set of representative aspects of the first odor is associated with a binary representative value, and wherein a second odor is considered as validly covering the at least one representative aspect of the first odor when:
the second odor belongs to the set of odors;
the second odor is characterized by the at least one representative aspect; and
the second odor is not characterized by any representative aspect out of the set of representative aspects of the first odor.

3. The method of claim 1, wherein at least one representative aspect of the set of representative aspects of the first odor is associated with non-binary representative values, and wherein a second odor is considered as validly covering the at least one representative aspect when:
the second odor belongs to the set of odors;
the second odor is characterized by the at least one representative aspect with associated representative value that is not lower than respective non-binary representative value of the first odor; and
when the second odor is characterized by a representative aspect out of the set of representative aspects of the first odor, a representative value associated with said respective aspect is negligible.

4. The method of claim 1, further comprising identifying VCA odors with regard to all odors in the set of odors; and processing data informative of the VCA odors to identify a set of primary odors for all odors in the set of odors.

5. The method of claim 4, wherein processing data informative of the VCA odors to identify the set of primary odors for all odors in the set of odors comprises reducing to a set cover problem and applying a set cover algorithm.

6. The method of claim 1, wherein identifying the set of primary odors for all odors in the set of odors is provided in accordance with similarity requirements, and wherein the similarity requirements are configured differently for different odor items or groups thereof.

7. The method of claim 1, wherein at least part of the odor items is represented by mixtures of respective material sources.

8. The method of claim 1, wherein at least part of the primary odors corresponds to mixtures of the odor items from the inventory.

9. The method of claim 1, wherein the digital olfactory application is reformulating a target odor, the inventory of odor items comprises odor items testable during the reformulating, the first odor is the target odor and the identified set of primaries is usable for removing from the inventory redundant odor items similarly contributing to the target odor and/or removing irrelevant odor items not contributing into the target odor.

10. The method of claim 1, wherein the digital olfactory application is maintaining the inventory of odor items, and the identified set of primaries is usable for optimizing the inventory by removing from an inventory listing at least part of redundant odor items with similar sets of primary odors.

11. A computing system useable for a digital olfactory application incorporating a digital olfactory technique, the system comprising a processing and memory circuitry (PMC) configured to:
obtain data informative of a set of odors corresponding to an inventory of odor items, each odor being characterized by its set of odor-related representative aspects in one or more odor-related spaces;
for a first odor, identify, within the set of odors, all odors that validly cover the set of representative aspect of the first order, thus giving rise to VCA odors with regard to the first odor;
process data informative of the VCA odors to identify a set of primary odors for the first odor; and
use the set of primary odors in the digital olfactory application.

12. The computing system of claim 11, wherein a set of odor-related representative aspects is constituted merely by aspects selected, among odor-related aspects characterizing a given odor, in accordance with their importance for similarity between the odors in the set of odors.

13. The computing system of claim 11, wherein the PMC is further configured to identify VCA odors with regard to all odors in the set of odors; and process data informative of the VCA odors to identify a set of primary odors for all odors in the set of odors.

14. The computing system of claim 13, wherein processing data informative of the VCA odors to identify the set of primary odors for all odors in the set of odors comprises reducing to a set cover problem and applying a set cover algorithm.

15. The computing system of claim 11, wherein identifying the set of primary odors for all odors in the set of odors is provided in accordance with similarity requirements, and wherein the similarity requirements are configured differently for different odor items or groups thereof.

16. The computing system of claim 11, wherein at least part of the odor items is represented by mixtures of respective material sources.

17. The computing system of claim 11, wherein at least part of the primary odors corresponds to mixtures of the odor items from the inventory.

18. The computing system of claim 11, wherein the digital olfactory application is reformulating a target odor, the inventory of odor items comprises odor items testable during the reformulating, the first odor is the target odor and the identified set of primaries is usable for removing from the inventory redundant odor items similarly contributing to the target odor and/or removing irrelevant odor items not contributing into the target odor.

19. The computing system of claim 11, wherein the digital olfactory application is maintaining the inventory of odor items, and the identified set of primaries is usable for optimizing the inventory by removing from an inventory listing at least part of redundant odor items with similar sets of primary odors.

20. A non-transitory computer-readable medium comprising instructions that, when executed by a computing system comprising a memory storing a plurality of program components executable by the computing system, cause the computing system to:
obtain data informative of a set of odors corresponding to an inventory of odor items, each odor being characterized by its set of odor-related representative aspects in one or more odor-related spaces;
for a first odor, identify, within the set of odors, all odors that validly cover the set of representative aspect of the first order, thus giving rise to VCA odors with regard to the first odor;
process data informative of the VCA odors to identify a set of primary odors for the first odor; and
use the set of primary odors in the digital olfactory application.
